(19) United States
(12) Patent Application Publication
(10) Pub. No.: US 2023/0316296 A1
(43) Pub. Date: Oct. 5, 2023

(54) APPARATUSES AND METHODS FOR GENERATING AUGMENTED REALITY INTERFACE

(71) Applicant: Shopify Inc., Ottawa (CA)

(72) Inventors: Daniel BEAUCHAMP, Toronto (CA); Sanjiv SIRPAL, Oakville (CA); Andrew NGO, Toronto (CA)

(21) Appl. No.: 17/707,379

(22) Filed: Mar. 29, 2022

(51) Int. Cl. G06Q 30/00; G06Q 30/06; G06V 10/62; G06V 20/20; G06V 20/40; G06T 19/00

(52) U.S. Cl. CPC G06Q 30/016; G06Q 30/0643; G06V 10/62; G06V 20/20; G06V 20/46; G06T 19/006

(57) ABSTRACT

Methods and apparatuses are disclosed for generating an augmented reality (AR) interface. An input frame is processed to detect and track an object in the input frame. The detected object is identified as an identified purchased product based on a query of a purchase history associated with an identified user account. In response to identifying the detected object as the identified purchased product, one or more virtual user interface elements associated with respective one or more post-purchase actions are provided.

### FIELD

The present disclosure relates to methods and apparatuses for generating an augmented reality interface, including an augmented reality interface providing virtual user interface elements related to a purchased product.

### BACKGROUND

Augmented reality (AR) relates to the enhancement of real-world experiences using computer-generated or virtual content. In some cases, AR enables a user to interact with an environment that involves both real-world and virtual components. For example, an AR image or video may involve a virtual object, such as a virtual user interface element (e.g., a virtual selection button, a virtual prompt or a virtual pop-up, among other possibilities), being displayed together with real-world objects in the scene.

### SUMMARY

Many existing AR interfaces involve the user only as a passive consumer of AR media (e.g., viewing virtual objects or virtual information displays overlaid on a view of the physical environment). Although some existing AR interfaces enable contextual information to be provided virtually in relation to a real-world object, such AR interfaces typically do not enable different user interactions depending on the state of the object (e.g., depending on the age of the object, depending on the condition or damage to the object, depending on the newness of the object, or depending on other observable state).

There are certain types of useful user interactions that are particularly dependent on the state of an object, which existing AR interfaces may not account for. For example, post-purchase actions such as accessing a user manual, initiating a refund or posting a review may be relevant to an object that is newly purchased by a user, but may be less relevant if the object has not been purchased by the user or if the object has been in the user's ownership for a long time. Existing AR interfaces that are able to classify an object or even identify a specific model or make of the object still typically do not consider the state of the object.

The present disclosure, in various examples, presents solutions to a problem that is specific to computers and in particular generation of AR interfaces. A challenge in designing AR interfaces is to ensure that the user is presented with a user-friendly interface with relevant virtual elements tailored to a real-world object. Because a user's interactions with an AR interface is constrained by the limits of technology (e.g., limits to computing resources, memory, processor power and/or capabilities of the input/output devices), it is important that the user is able to interact with an AR interface in a natural way, so as to enhance the user experience rather than introducing unintended barriers (e.g., overly complex options, having to navigate through a menu, having to dismiss irrelevant options, etc.). It should be understood that this is not a trivial problem.

In various examples, the present disclosure describes methods and apparatuses that provide a user with an AR interface including virtual user interface elements (e.g., virtual selection options) dependent on identifying a detected real-world object as a purchased product associated with the user (e.g., based on a query of a purchase history associated with a user account of the user). This provides the technical advantage that an AR interface can be generated that includes virtual user interface elements tailored to the state of the object (e.g., a recently purchased object and/or a damaged object). This also provides the technical advantage that the AR interface can adapt to the user's experience with the real-world object in a more natural way, rather than forcing the user to navigate through options that may not be relevant. In this way, computing resources (e.g., memory resources, processor power, battery life, etc.) can be used in a more efficient way, rather than being wasted on presenting and navigating through virtual user interface elements that are not relevant.

In some examples, the generated AR interface may include virtual user interface elements that prompt the user to physically manipulate the real-world object. The physical manipulation may be detected and/or confirmed (e.g., using a pose detection neural network), to enable completion of an action associated with a selected virtual option. The AR interface may thus guide the user in physical manipulation of the object, in order to obtain the required information or to obtain the required orientation of the object for performing the action. In examples where completion of the selected action is contingent on the user's physical manipulation of the object, a technical advantage is provided in that the authenticity and/or state of the object can be checked in a relatively quick and user-intuitive way. Another technical advantage is that data (e.g., video data, image data, etc.) can be obtained from physical manipulation of the object, while reducing the risk that the obtained data is sub-par (e.g., if the object is not manipulated in the correct way). Thus, the computing resources (e.g., memory, processor power, battery life, etc.) associated with obtaining and storing such data can be used more efficiently.

In some example aspects, the present disclosure describes a method including: processing an input frame captured by an image capture device to detect and track an object in the input frame; identifying the detected object as an identified purchased product based on a query of a purchase history associated with an identified user account; and in response to identifying the detected object as the identified purchased product, providing, via an image output device, one or more virtual user interface elements associated with respective one or more post-purchase actions.

In some examples, the method may further include: determining a temporal difference between a purchase time of the identified purchased product in the purchase history and a current time; and identifying the one or more post-purchase actions for which the associated one or more virtual user interface elements is to be provided, based on the temporal difference.

In some examples, the one or more post-purchase actions may be identified from a set of available post-purchase actions, where each available post-purchase action may be associated with a respective post-purchase temporal range, and where the one or more post-purchase actions may be identified based on a match between the determined temporal difference and the respective post-purchase temporal range associated with each respective one or more post-purchase actions.

In some examples, one of the one or more virtual user interface elements may be a prompt to perform a physical manipulation of the detected object, and where the post-purchase action associated with the one virtual user interface element may be completed after performance of the physical manipulation.

In some examples, completion of the post-purchase action may include: storing one or more subsequent input frames, captured by the image capture device, including the detected object during or after performance of the physical manipulation.

In some examples, the one virtual user interface element may be a first prompt to perform a first physical manipulation of the detected object, where subsequent to the first prompt a second virtual user interface element may be provided that is a second prompt to perform a second physical manipulation of the detected object, and where the stored one or more subsequent input frames may be tagged with timestamps corresponding to the first prompt and the second prompt.

In some examples, the method may include: processing one or more subsequent input frames, captured by the image capture device, to confirm performance of the physical manipulation of the detected object; and completing the post-purchase action associated with the one virtual user interface element in response to confirming the performance of the physical manipulation.

In some examples, confirming the performance of the physical manipulation may include: processing the one or more subsequent input frames to detect a change in pose of the detected object or to detect a changed reference marker on the detected object.

In some examples, completion of the post-purchase action may include: detecting a difference in the detected object based on a comparison between a captured image of the detected object after performance of the physical manipulation and a stored previous image of the detected object or a reference object associated with the identified purchased product; and completing the post-purchase action associated with the one virtual user interface element in response to the detected difference.

In some examples, completion of the post-purchase action may include: detecting, in a captured image of the detected object after performance of the physical manipulation, an identifier; and completing the post-purchase action associated with the one virtual user interface element in response to the detected identifier matching a stored identifier of the identified purchased product.

In some examples, the method may include: identifying the one or more post-purchase actions for which the associated one or more virtual user interface elements is to be provided, based on a predefined set of one or more post-purchase actions associated with the identified purchased product.

In some examples, at least one of the one or more virtual user interface elements may be provided as a virtual overlay superimposed on the detected object.

In some examples, the one or more post-purchase actions may include at least one of: an action to view an interactive user manual; an action to purchase a warranty; an action to initiate a return or exchange; an action to report a defect; an action to create or view a virtual note; or an action to post a review.

In some example aspects, the present disclosure describes an apparatus including a processing unit coupled to communicate with an image capture device and an image output device. The processing unit is configured to: process an input frame captured by the image capture device to detect and track an object in the input frame; identify the detected object as an identified purchased product based on a query of a purchase history associated with an identified user account; and in response to identifying the detected object as the identified purchased product, provide, via the image output device, one or more virtual user interface elements associated with respective one or more post-purchase actions.

In some examples, one of the one or more virtual user interface elements may be a prompt to perform a physical manipulation of the detected object, and where the post-purchase action associated with the one virtual user interface element may be completed after performance of the physical manipulation.

In some examples, the processing unit may be further configured to: process one or more subsequent input frames, captured by the image capture device, to confirm performance of the physical manipulation of the detected object; and cause completion of the post-purchase action associated with the one virtual user interface element in response to confirming the performance of the physical manipulation.

In some examples, completion of the post-purchase action may include: detecting a difference in the detected object based on a comparison between a captured image of the detected object after performance of the physical manipulation and a stored previous image of the detected object or a reference object associated with the identified purchased product; and completing the post-purchase action associated with the one virtual user interface element in response to the detected difference.

In some examples, the processing unit may be further configured to: determine a temporal difference between a purchase time of the identified purchased product in the purchase history and a current time; and identify the one or more post-purchase actions for which the associated one or more virtual user interface elements is to be provided, based on the temporal difference.

In some examples, the processing unit may be further configured to perform any of the example methods described above.

In some examples, the apparatus may be one of: a smartphone; a tablet; a wearable device; or a projection device.

In some example aspects, the present disclosure describes a non-transitory computer readable medium having instructions stored thereon. The instructions, when executed by a processing unit of an apparatus, cause the apparatus to: process an input frame captured by an image capture device to detect and track an object in the input frame; identify the detected object as an identified purchased product based on a query of a purchase history associated with an identified user account; and in response to identifying the detected object as the identified purchased product, provide, via an image output device, one or more virtual user interface elements associated with respective one or more post-purchase actions.

In any of the preceding examples, the computer readable medium may include instructions to implement any of the apparatuses or methods described above.

### BRIEF DESCRIPTION OF THE DRAWINGS

Reference will now be made, by way of example, to the accompanying drawings which show example embodiments of the present application, and in which:

FIG. 1 is another block diagram of an example e-commerce platform, showing example details of an AR interface generator, in accordance with examples of the present disclosure;

FIG. 2 is a flowchart illustrating an example method for generating an AR interface, in accordance with examples of the present disclosure;

FIGS. 3 and 4 illustrate some examples of AR interfaces that may be generated in accordance with examples of the present disclosure;

FIG. 5 is a block diagram of an example e-commerce platform, in which examples described herein may be implemented;

FIG. 6 is an example homepage of an administrator, which may be accessed via the e-commerce platform of FIGS. 5; and

FIG. 7 is another block diagram of an example e-commerce platform, including an AR interface generator, in accordance with examples of the present disclosure.

Similar reference numerals may have been used in different figures to denote similar components.

### DETAILED DESCRIPTION

Examples of the present disclosure describe methods and systems to enable generation and/or viewing of an augmented reality (AR) interface. In the present disclosure an AR interface may refer to any user interface (UI) in which a UI element is displayed as a virtual object (i.e., a virtual UI element) in relation to a real-world object. In particular, the AR interface causes the virtual UI element to be perceived by a user to be part of the physical environment of the real-world object or to be part of the real-world object.

For example, a real-world object may be captured by a camera and displayed on a display screen, and a virtual UI element may be superimposed on the object in the display screen in a manner that causes the virtual UI element to appear to be part of the object viewed via the display screen. In another example, a virtual UI element may be displayed as a holographic projection near or over a real-world object in a manner that causes the virtual UI element to appear to be on or covering the object viewed in the physical environment. In another example, a real-world object may be viewed through a viewport of an AR viewer (e.g., a wearable headset, or a head-up display (HUD) on a vehicle), and a virtual UI element may be displayed or projected on the viewport such that the virtual UI element appears to be on or part of the real-world object when viewed through the viewport. Other implementations of the AR interface may be possible.

In the context of the present disclosure, a virtual object that “overlays” or is “overlaid” onto a real-world scene may visually obscure at least part of a background or other object in the real-world scene. For example, in an AR interface, a virtual UI element may overlay a real-world object such that the virtual UI element partially blocks the user's view of the real-world object (thus appearing to sit on top of or be part of the real-world object). In another example, a virtual UI element may be next to or extend from the real-world object such that the virtual UI element does not block the user's view of the real-world object (thus appearing to be part of the physical environment of the real-world object).

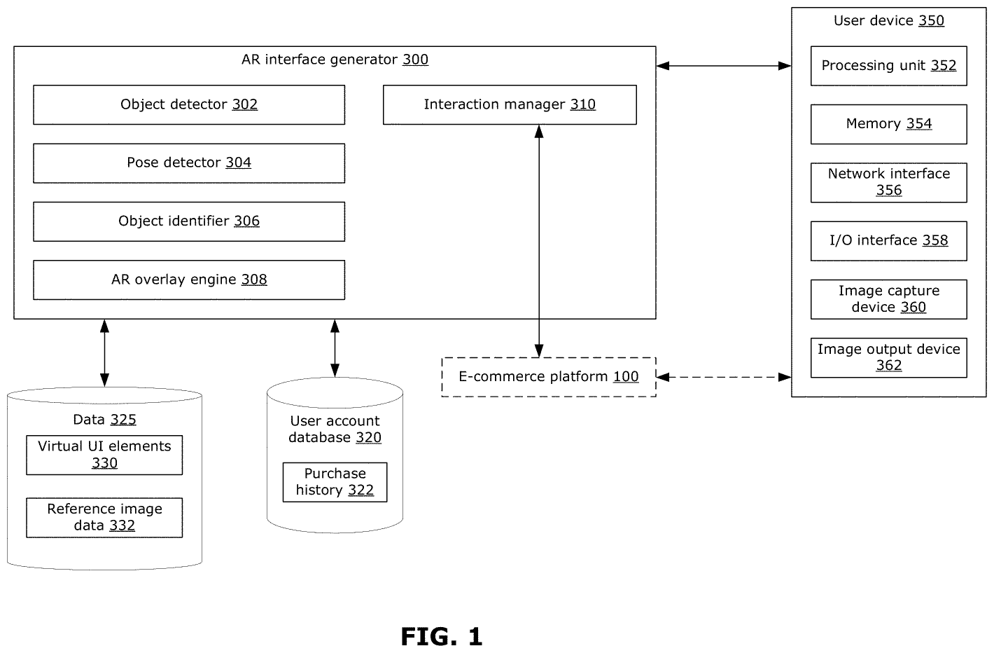

Reference is first made to FIG. 1, which is a block diagram showing an AR interface generator 300. FIG. 1 illustrates a user device 350 interacting with the AR interface generator 300. The AR interface generator 300 is an example of a computer-implemented system that implements the functionality described herein. Further details of the AR interface generator 300 are discussed further below.

The user device 350 may be any electronic device capable of providing an AR interface (or capable of communicating with an external image output device to provide the AR interface). Examples of suitable electronic devices (which may or may not be AR-dedicated devices) include wearable devices (e.g., head-mounted display (HMD) devices, AR glasses, smart watches, etc.), mobile devices (e.g., smartphones, tablets, laptops, etc.) and/or projection devices (e.g., smart projectors, 3D lamps, holographic projectors, etc.) among others. Examples of the present disclosure may also be implemented using other electronic devices, such as desktop computing devices, workstations, tracking systems, and other computing devices.

Example components of the user device 350 are now described, which are not intended to be limiting. It should be understood that there may be different implementations of the user device 350.

The user device 350 includes at least one processing unit 352, such as a processor, a microprocessor, an application-specific integrated circuit (ASIC), a field-programmable gate array (FPGA), a dedicated logic circuitry, a graphics processing unit (GPU), a central processing unit (CPU), a dedicated artificial intelligence (AI) processor unit, or combinations thereof.

The user device 350 includes at least one memory 354, which may include a volatile or non-volatile memory (e.g., a flash memory, a random access memory (RAM), and/or a read-only memory (ROM)). The non-transitory memory 354 may store instructions for execution by the processing unit 352, such as to enable communication with the AR interface generator 300 and/or to enable the user device 350 to output (e.g., display or project) one or more virtual objects. For example, the memory 354 may store instructions for executing an app (or other software application) that enables the user device 350 to communicate with the AR interface generator 300 (e.g., provide captured frames and detected user inputs to the AR interface generator 300, and receive instructions for rendering AR virtual objects from the AR interface generator 300), in order to provide an AR interface to a user.

The user device 350 includes at least one network interface 356 for wired or wireless communication with an external system or network (e.g., an intranet, the Internet, a P2P network, a WAN and/or a LAN), and in particular for communication with the AR interface generator 300 in the example shown. In some examples, the network interface 356 may also enable the user device 350 to communicate with other systems (not shown) or another user device (not shown) via a network and/or directly.

The user device 350 also includes at least one input/output (I/O) interface 358, which interfaces with an image capture device 360 such as a camera, and at least one image output device 362 such as a display and/or a projector (depending on the capabilities of the user device 350). In some examples, the same component may serve as both input and output device (e.g., the image output device 362 may be a touch-sensitive display that detects touch inputs as well as providing display outputs). The image capture device 360 may include or be an optical camera that is capable of capturing a sequence of frames as video data. In some examples, the image capture device 360 may also be capable of capturing depth information (e.g., the image capture device 360 may include or be an infrared sensor), or the image capture device 360 may include multiple sub-units that each capture different types of video data (e.g., the image capture device 360 may be a combination of an optical camera and an infrared camera, such that the captured image data includes both RGB and depth data). The user device 350 may include other input devices (e.g., buttons, microphone, touchscreen, keyboard, infrared sensor, etc.) and other output devices (e.g., speaker, vibration unit, etc.). The user device 350 may also include other sensor units and/or components that may sense the environment of the user device 350 and generate corresponding sensor data, such as a LIDAR sensor, an inertial measurement unit (IMU), an accelerometer, a gyroscope and/or a magnetometer, among other possibilities.

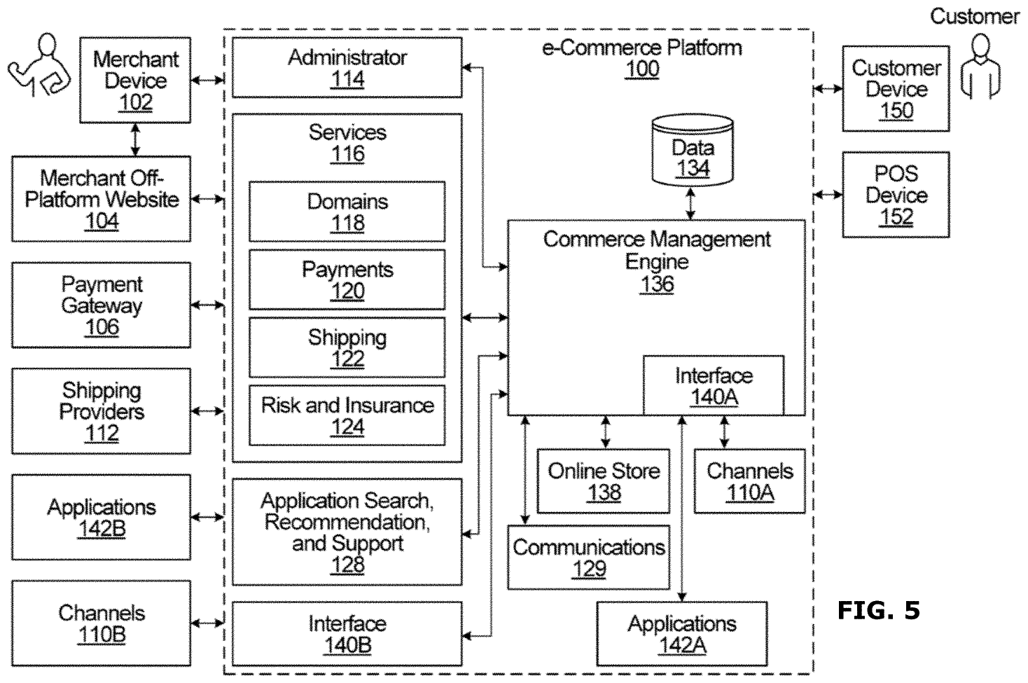

A user may interact with an e-commerce platform 100 via the user device 350 to make a purchase from an online store (e.g., as described further below with respect to FIG. 5). In such instances, the user device 350 may be an instance of a customer device, as described with reference to FIG. 5. The user's interactions with the e-commerce platform 100, including purchases made on the e-commerce platform 100, may be associated with a user account maintained in a user account database 320. The user account database 320 may be accessible to the AR interface generator 300. Purchases may be tracked in a purchase history 322 associated with the user account associated with the user. The purchase history 322 may store data records of all purchases (and possibly also refunds or exchanges) made using the associated user account for a defined period of time (e.g., in the past year) or an undefined period of time (e.g., since the creation of the user account). Each data record in the purchase history may include, for example, an identifier of the purchased product (e.g., a product identifier, such as a universal product code (UPC) and/or a unique identifier specific to a particular batch or particular instance of the product, such as a lot number, blockchain token or digital fingerprint), a purchase time (e.g., date and time of the purchase), and optionally a retailer identifier (e.g., an identifier of the online retail store from which the product was purchased).

There are various ways in which a user may be associated with a user account. For example, the user may log into a particular user account via the user device 350 (e.g., by providing the required login credentials such as username and password). In another example, the user device 350 may be registered as being associated with a particular user account, such that user interactions via the user device 350 are automatically associated with the particular user account. In some examples, multiple users may be associated with a single user account. For example, multiple family members may be associated with a family user account; or multiple company workers may be associated with a company user account. In some examples, one user may be associated with multiple user accounts. For example, a user may be associated with both a personal user account and a company user account. If a user is associated with multiple user accounts, the association with different user accounts may be recorded in a user profile that is associated with the user's personal user account. In another example, information stored in the user profile (e.g., an address, a phone number etc.) may be used to identify another user account that may be associated with the user (e.g., a user's home address stored in a user profile associated with the user's personal user account may be the same as the home addressed associated with a family user account or associated with a family member's personal user account). Thus, when a user interacts with the AR interface generator 300 (or optionally with the e-commerce platform 100) via the user device 350, at least one user account (which may or may not be a person account of the user) may be identified from the user account database 320.

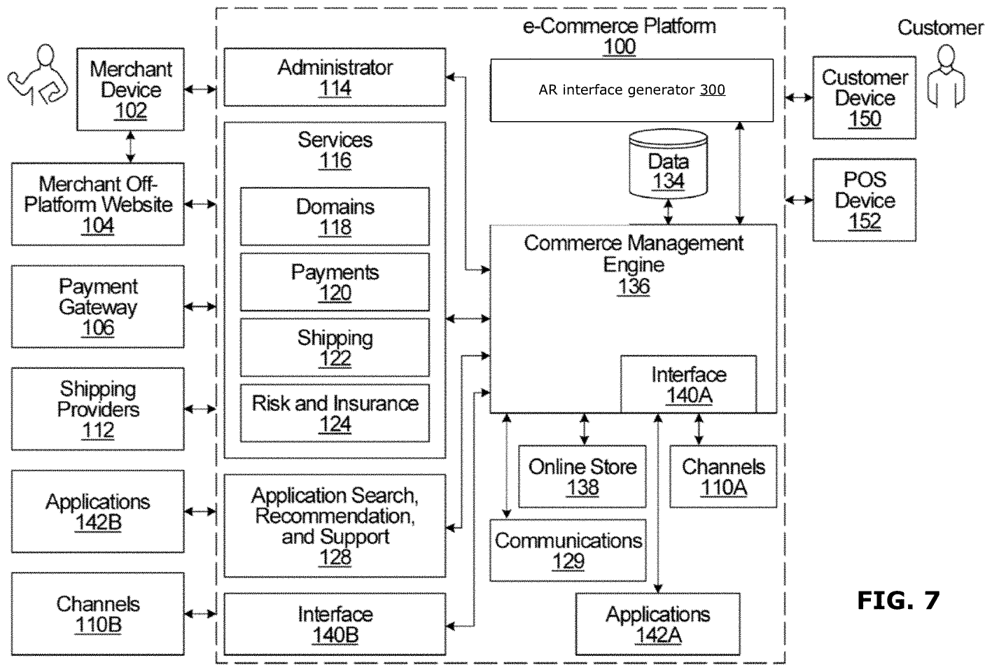

Some details of the AR interface generator 300 are now discussed. The AR interface generator 300 may be provided as a software application of an AR platform, or may be provided as a service (e.g., a cloud-based service) accessible by the user device 350. The AR interface generator 300 may be a standalone service (e.g., implemented as a standalone module on a server) or may be part of other services provided by a platform, such as an AR platform or as part of the e-commerce platform 100 (as discussed further below with reference to FIG. 7). The AR interface generator 300 is shown to include components such as an object detector 302, a pose detector 304, an object identifier 306, an AR overlay engine 308 and an interaction manager 310. It should be understood that these components are not intended to be limiting. For example, the AR interface generator 300 may be implemented using greater or fewer components; one or some components shown to be part of the AR interface generator 300 may be implemented outside of the AR interface generator 300; functions described as being performed by a particular component may be performed by a different component; or functions described as being performed by any of the components may instead be an overall function of the AR interface generator 300.

The AR interface generator 300 communicates with a data facility 325, which in this example stores virtual UI elements 330. The virtual UI elements 330 may include elements such as virtual selection buttons, virtual prompts, virtual pop-ups, virtual labels, virtual icons, etc. Each virtual UI element 330 may be stored as a 2D or 3D data object, and may be used to generate one or more instances of the virtual UI element 330 as an AR overlay. The data facility 325 may also store other virtual objects other than virtual UI elements (e.g., virtual backgrounds, virtual 3D models, etc.). The data facility 325 in this example also stores reference image data 332. Image data in the present disclosure may refer to 2D static images (e.g., photographs), 3D static images (e.g., 3D models), 2D dynamic images (e.g., videos) and/or 3D dynamic images (e.g., 3D animations). In general, image data may include one or more frames of image data, where each frame is a single timestep (e.g., a video may include multiple consecutive frames of image data). Reference image data 332 may be a 2D or 3D reference of a product that can be purchased (or could have been purchased) from an online store (e.g., an online store hosted by the e-commerce platform 100). In some examples, the data facility 325 may be hosted or maintained by the e-commerce platform 100. For example, reference image data 332 (e.g., a reference photograph or a reference 3D model) for a given product may be uploaded by a merchant who offers the product for sale at their online store. The reference image data 332 may be used by the object identifier 306 to identify a real-world object as an instance of the given product. The interaction manager 310 may also determine a state of the real-world object by comparing the real-world object to the reference image data 332, for example to determine if the real-world object is damaged, defective, broken, aged, etc.

The determined state of the real-world object may be any observable state, for example based on sensor data obtained by sensors of the user device 350 (including image data obtained by the image capture device 360). For example, a state of the real-world object may be a visually-determined state (e.g., newness of the object, damage to the object, etc.), an audibly-determined state (e.g., beeping or humming from the object, lack of sound from the object, etc.), a temperature-based state (e.g., warmth of the object, etc.), a motion-based state (e.g., speed of a component of the object, speed of rotation of the object, etc.), and combinations thereof, among other possibilities.

The determined state of the real-world object may be a state that is relevant to the functions of the object. For example, if the object is a piece of clothing, the determined state of the object may include whether the object is stained or ripped (which may be determined based on image data from the image capture device 360). In another example, if the object is a speaker, the determined state of the object may include whether the speaker is outputting audio or not (which may be determined based on audio input data from an audio sensor or microphone array). In another example, if the object is a heater, the determined state of the object may include whether the object is emitting heat (which may be determined based on infrared data from an infrared sensor). In another example, if the object is a fan, the determined state of the object may include whether the fan blades are rotating or the speed of their rotation (which may be determined based on a sequence of frames from the image capture device 360). The determined state of the real-world object may also be dependent on the sensor capabilities of the user device 350 (e.g., the user device 350 may include sensors such as a microphone, an infrared sensor, etc., in addition to the image capture device 360).

In some examples, the AR interface generator 300 may select virtual UI element(s) 330 to include in the AR interface not only based identifying the real-world object as a purchased product (as discussed further below), but also based on the state of the real-world object (e.g., based on the detected mechanical, physical, or other observable properties of the object). Certain types of objects may be associated with certain predefined possible states. For example, if a real-world object is detected and identified to be a book, the AR interface generator 300 may recognize that the book can be opened along certain pivot points. The AR interface generator 300 may further identify the book as being in one of several possible predefined states (e.g., front-view state, back-view state, open state and closed state may be predefined for a book), for example based on the detected orientation, size and/or appearance of the book. The AR interface generator 300 may select appropriate virtual UI element(s) 330 to include in the AR interface based on the identified state. In some examples, the AR interface generator 300 may identify a transition from one state of the object to another state (e.g., from a closed state of a book to an open state), and the identified transition may be a trigger for the AR interface generator 300 to select a virtual UI element 330 (which is predefined to be associated with the state transition) to include in the AR interface. There may be various types of real-world objects for which the AR interface generator 300 may identify a state (from a set of possible states) and thus select appropriate virtual UI element(s) 330 to include in the AR interface. Some examples of such real-world objects include a shirt (e.g., having predefined states: folded, rolled, front, back, with respective associated virtual UI elements 330); a drinking glass (e.g., having predefined states: full, half-full, empty, with respective associated virtual UI elements 330); a food container (e.g., having predefined states: unopened, opened, full, empty, with respective associated virtual UI elements 330); a heater (e.g., having predefined states: warm, hot, cool, with respective associated virtual UI elements 330); or a radio (e.g., having predefined states: loud, quiet, off, with respective associated virtual UI elements 330); among other possibilities.

The data facility 325 may also store AR image data (not shown). AR image data may be image data that includes one or more frames having both virtual object(s) (e.g., virtual UI element(s) 330) and real-world object(s). For example, AR image data may include an AR photograph where a virtual object is overlaid on a real-world environment or real-world object in the stored photograph, or an AR video where a virtual object is overlaid on a real-world environment or real-world object in at least a segment of the stored video. As will be discussed further below, user interactions enabled by the AR interface generator 300 may be used to generate and store AR image data.

As mentioned previously, the AR interface generator 300 may include an object detector 302 that performs operations to detect and track a real-world object in one or more input frames (e.g., frames of a video captured by the image capture device 360 of the user device 350 and communicated to the e-commerce platform 100).

In the present disclosure, object detection is used to refer to the task of estimating or predicting the location (e.g., bounding box or bounding volume) of an object. Object classification is used to refer to the task of estimating or predicting the category (also referred to as class) of the detected object. In some examples, object detection and classification may be performed jointly (e.g., a single neural network or algorithm may be used to both detect an object and classify the detected object) or separately (e.g., separate neural networks or algorithms may be used to perform each task).

The object detector 302 may be any suitable object detection and tracking algorithm that enables real-time object detection and tracking, including machine learning-based object detection algorithms that may be used with classical motion tracking. In some examples, the object detector 302 may perform both object detection and classification (e.g., using a neural network that has been trained to detect and classify objects in real-time, such as the You Only Look Once (YOLO) or YOLOv3 algorithms as described in Redmon et al. “You Only Look Once: Unified, Real-Time Object Detection” arXiv:1506.02640 and Redmon et al. “YOLOv3: An Incremental Improvement” arXiv:1804.02767). In some examples, the object detector 302 may perform only object detection (e.g., the object detector 302 may be a convolutional neural network (CNN) trained for object detection) and a separate object classifier (not shown) may be used for object classification (e.g., a separate CNN may be trained to perform object classification on the bounding box of the detected object). In some examples, object classification may not be required and instead a detected object may be identified using an object identifier 306 discussed further below.

In some examples, the AR interface generator 300 may also include a pose detector 304 that performs operations to estimate the pose of a detected real-world object. The pose of an object refers to its orientation relative to a static frame of reference, and may be expressed as pitch, yaw and roll (or the three corresponding Euler angles). In some examples, the pose detector 304 may additionally or alternatively perform operations to estimate the pose of a detected real-world object based on detected keypoints. For example, the pose detector 304 may use keypoint detection to estimate the configuration of bendable, foldable or otherwise physically reconfigurable objects (e.g., a book, a robotic arm, etc.). In some examples, pose detection may include location detection, such that the pose detection may be referred to as 6D pose detection (where there are three degrees-of-freedom (DOF) for the location and three DOF for the orientation). This may also be referred to as 6D pose estimation. The pose detector 304 may be any suitable pose detection algorithm that enables real-time detection of a pose in 3D space, including machine learning-based algorithms. For example, the pose detector 304 may be a neural network that has been trained to perform 6D pose estimation such as PoseCNN or Deep Object Pose Estimation (DOPE) algorithms (e.g., as described in Xiang et al. “PoseCNN: A Convolutional Neural Network for 6D Object Pose Estimation in Cluttered Scenes” arXiv:1711.00199 and Tremblay et al. “Deep Object Post Estimation for Semantic Robotic Grasping of Household Objects” arXiv:1809.10790). In other examples, the pose detector 304 may perform pose detection by detecting reference markers on a real-world object (e.g., reference QR codes or other reference indicators that may be printed or placed on the object), where each reference marker indicates a predefined part of the object. By detecting the presence of one or more reference markers (e.g., using QR recognition algorithms) in a frame, the pose detector 304 may thus infer the pose of the object.

The AR interface generator 300 may include an object identifier 306 that performs operations to identify the detected real-world object as a product that may be purchased (or may have been purchased) (e.g., purchased from an online store on the e-commerce platform 100).

In the present disclosure, object identification is used to refer to the task of estimating or predicting a specific brand, model or make of an object (as distinct from object classification which estimates or predicts the broad category of an object). Object identification may be performed following object detection. For example, the object identifier 306 may process only the portion of an input frame that is within the bounding box or bounding volume detected by the object detector 302 (e.g., to help improve accuracy of object identification by cropping out the background). The object identifier 306 enables the detected real-world object to be identified in a manner that is more specific than typical object classification algorithms. For example, where an object classification algorithm (e.g., YOLOv3) may detect and classify an object as a “car”, the object identifier 306 may further identify the specific model of the car such as a “Chevrolet”.

The object identifier 306 may be any suitable neural network trained to perform an object identification task (e.g., including text recognition, foreign language recognition and translation, image matching, etc.) using an input image. For example, the object identifier 306 may be a CNN that has been trained to identify a real-world object based on matching the input image with at least one product image that is stored in the data facility 325 (e.g., a 2D image of the product may be uploaded to the data facility 325 by a merchant offering the product at an online store). When a match is found, the object identifier 306 may identify the real-world object using the product identifier (e.g., product number, product name, UPC, etc.) associated with the match product image.

The object identifier 306 may alternatively or additionally perform object identification by recognizing a computer-readable identification such as barcode, QR code or other unique identifier (e.g., lot number, model number, etc.) that may be provided on the real-world object. For example, the object identifier 306 may use any suitable barcode or QR code scanning algorithm, or any suitable text recognition algorithms. The computer-readable identification may include computer-readable identification that is not necessarily based on visual detection. For example, the computer-readable identification may include near field communication (NFC) tags that may be read using an appropriate NFC sensor of the user device 350 (and the information may then be communicated by the user device 350 to the AR interface generator 300). In some examples, the use of such computer-readable tags may, in addition to enabling identification of the real-world object, also enable detection of the position and/or pose of the object.

The AR interface generator 300 may include an AR overlay engine 308. The AR overlay engine 308 performs operations to generate an AR overlay (e.g., a virtual 2D or 3D object) that can be outputted by the image output device 362 of the user device 350, to provide an AR interface to a user. As will be discussed further below, the AR overlay may be generated using a selected virtual UI element 330 that is associated with a post-purchase action. The AR overlay engine 308 may use predefined anchor point(s) of the virtual UI element 330 to anchor the AR overlay relative to a detected real-world object for which the virtual UI element 330 is being provided. For example, the AR overlay engine 308 may anchor a virtual selection button to a bottom edge of a detected real-world cereal box. The AR overlay engine 308 may render and overlay the virtual UI element 330 according to predefined parameters associated with each virtual UI element 330.

The AR overlay engine 308 may use outputs from the object detector 302 and/or pose detector 304 to update the position, size and/or pose of the rendered virtual UI element 330 as the real-world object moves in the real-world environment.

For simplicity, examples of the present disclosure describe one virtual UI element 330 being generated as an AR overlay for one detected real-world object. However, it should be understood that in other examples there may be two or more virtual UI elements 330 rendered as AR overlays for a given real-world object. For example, two virtual UI elements 330 may be overlaid on a single real-world object where there are two different post-purchase actions that may be performed (e.g., an action to initiate a refund and another action to initiate an exchange).

The AR interface generator 300 may include an interaction manager 310. The interaction manager 310 performs operations to track and manage user interactions (via the user device 350) with the generated AR interface, for example by tracking user inputs indicating selection of a virtual UI element 330. The interaction manager 310 may also perform operations to identify one or more post-purchase actions, from a set of available post-purchase actions, that should be provided via the AR interface. As will be discussed further below, the post-purchase action(s) identified by the interaction manager 310 may be identified based on the purchase history associated with the user account identified with the user.

The interaction manager 310 may also perform operations to capture image data during the user's interactions with the AR interface, for example to generate an AR video or AR photograph (or non-AR video or photograph), which may be stored in the data facility 325.

In some examples, the interaction manager 400 may cooperate with the e-commerce platform 100 (e.g., cooperate with a commerce management engine of the e-commerce platform 100) to enable a selected post-purchase action to be at least partially carried out. For example, a post-purchase action may be related to transactions managed by the commerce management engine, such as initiating a refund, initiating an exchange, purchasing a warranty, purchasing an extended warranty, etc.

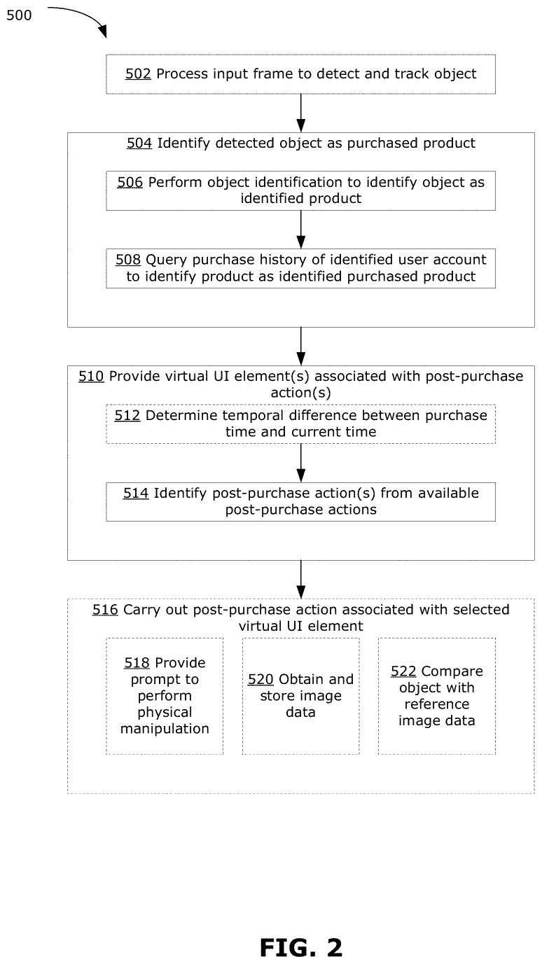

FIG. 2 is a flowchart illustrating an example method 500 that may be performed by the AR interface generator 300. For example, a computing system (e.g., a server, or a server cluster) having a processing unit implementing the AR interface generator 300 may execute computer-readable instructions to perform the method 500.

At an operation 502, an input frame captured by an image capture device (e.g., the image capture device 360 of the user device 350) is processed to detect and track a real-world object in the input frame. For example, the object detector 302 may be used to detect and track the object in the input frame. In some examples, the input frame may be a frame within a sequence of frames (e.g., a frame of a video), and the detected object may be tracked through multiple frames.

At an operation 504, the detected object is identified as an identified purchased product. The operation 504 may be performed using operations 506 and 508.

At the operation 506, object identification is performed to identify the object as an identified product. For example, the object identifier 306 may be used to identify the detected object as a particular product available for purchase (or formerly available for purchase) at an online store (e.g., an online store of the e-commerce platform 100). The object identifier 306 may, for example, use machine learning-based algorithms to match the detected object with reference image data 332 for a particular product (e.g., the detected object in the input frame may be matched with a reference 2D photograph or reference 3D model of the particular product).

At the operation 508, the purchase history associated with an identified user account is queried in order to identify the product as a purchased product for the user account. The identified user account may be any user account that is associated with the user who is interacting with the AR interface generator 300 via the user device 350. As mentioned previously, a user account may be identified for the user based on, for example, login credentials provided by the user, registration of the user device 350, user profile information indicating association with another user account (e.g., a family user account, a company user account, another user account having the same home address, etc.). After identifying the user account, the purchase history 322 associated with the user account may be queried to determine that the identified product is recorded in the purchase history 322.

In some examples, identifying the identified product as an identified purchased product in the purchase history 322 may not require that the identified product be the exact instance of the product in the purchase history. This may be the case where the product is a common commodity. For example, if the detected object is identified as a Brand A bottle of vitamins, it may not be necessary that the specific instance of the Brand A bottle of vitamins (e.g., exact lot number, expiry date, etc.) be identified in the purchase history. It may be sufficient that the purchase history includes a purchase of Brand A bottle of vitamins, even if it is not the exact same bottle that is currently detected in the input frame.

In other examples, identifying the identified product as an identified purchased product in the purchase history 322 may require that the identified product be the exact instance of the product in the purchase history. This may be the case where the product is more unique or more expensive. For example, if the detected object is identified as a Model B high performance bicycle, it may be necessary that the specific instance of the Model B high performance bicycle (e.g., unique product code, exact production number, etc.) be identified in the purchase history. This may be useful where post-purchase actions, such as initiating a refund or purchasing a warranty, are dependent on the exact instance of the product having been purchased by the user.

In some examples, querying the purchase history may include identifying the purchase time (e.g., timestamp including both date and time) of the identified purchased product. The purchase time may be used to determine how long ago the purchase was made. Although purchase time is described, it should be understood that information about other temporal milestones may be identified (from the purchase history as well as other product tracking data), including the delivery time of the product, the shipping time of the product, the reservation time of the product (if the user reserves or puts on hold the product prior to actual purchase), the receiving time of the product, etc.

Regardless of how the operation 504 is performed (e.g., using the operations 506 and 508), following the operation 504 the method 500 proceeds to an operation 510.

At the operation 510, in response to identifying the detected real-world object as the identified purchased product, one or more virtual UI elements are provided via an image output device (e.g., the image output device 362 of the user device 350). Each virtual UI element may be associated with a respective post-purchase action. For example, the AR interface generator 300 may use the AR overlay engine 308 and the interaction manager 310 to perform the operation 510. The operation 510 may be performed using optional operation 512 and operation 514

At the optional operation 512, a temporal difference between the purchase time (or other temporal milestone) of the purchased product (e.g., determined from the purchase history at the operation 508) and the current time is determined. The temporal difference may be determined in days, hours or minutes, for example.

At the operation 512, the post-purchase action(s) for which the associated virtual UI element(s) are to be provided are identified. The post-purchase action(s) may be identified from a set of available post-purchase actions, which may be predefined and stored (e.g., stored in the data facility 325, or stored by the e-commerce platform 100). For example, a set of available post-purchase actions may be predefined for a given product (e.g., predefined by the product's retailer and/or by the product's manufacturer). Each post-purchase action may be associated with a respective post-purchase temporal range for which that post-purchase action is valid. For example, if a post-purchase action is an action to initiate a refund, this action may only be valid for a temporal range of 30 days from the date of purchase; in another example, if a post-purchase action is an action to report a defect, this action may only be valid for a temporal range of 10 days from the date of purchase; in another example, if a post-purchase action is an action to create a review, this action may only be valid for a temporal range of 3 days from the date of purchase. The post-purchase temporal range associated with each post-purchase action may also be predefined (e.g., predefined by the product's retailer and/or by the product's manufacturer). Thus, the post-purchase action(s) for which the associated virtual UI element(s) is to be provided may be identified by matching the temporal difference between the purchase time (or other temporal milestone, such as delivery time, shipped time, reservation time, received time, etc.) and the current time, and post-purchase temporal range of each post-purchase action. Only those post-purchase actions for which the temporal difference falls within the associated post-purchase temporal range may be provided as virtual UI elements.

In some examples, there may be post-purchase action(s) that can be provided without considering the temporal difference. For example, there may be certain post-purchase action(s), such as purchasing a replacement, creating a recommendation, creating or viewing a virtual note, or viewing a user manual, that may be valid any time after the purchase date.

In some examples, there may be post-purchase action(s) that are available only to certain users. For example, a post-purchase action to create a virtual note may be restricted only to the user who actually purchased the product. Such a virtual note may be created as a virtual object that is viewable via the AR interface (e.g., may be a virtual object that is superimposed on the real-world object in the AR interface, to appear as a note attached to the real-world object). For example, a user may create a virtual note to be viewed by themselves, such as a reminder to change the batteries in a month. In another example, a user may create a virtual note to be viewed by another user, such as a reminder to clean the product regularly or a note about how to use the product. The user who created the virtual note may associated viewing permission with the virtual note, such that the virtual note may only be visible (via the AR interface) to certain selected user(s). In some examples, a user may create a virtual note in order to obscure some aspect of the product (e.g., a virtual note may be created to cover up a logo or some offending language on the product). It should also be understood that, in other examples, the post-purchase action to create or view a virtual note may not be restricted to certain users.

The post-purchase action(s) may be associated with virtual UI element(s) that are provided via the image output device, for interaction by the user. For example, the AR interaction generator 300 may communicate instructions to the user device 350 to cause the user device 350 to output the virtual UI element(s) via the image output device 362 (e.g., as an AR display or as an AR projection). At least one of the virtual UI element(s) may be provided as a virtual overlay superimposed on the detected object, for example. The virtual UI element(s) may include a virtual button, a virtual pop-up, a virtual prompt, a virtual dialog box, etc. The user may interact with the virtual UI element(s) as is typical for AR interactions (e.g., the user may touch or select a virtual UI element(s) in an AR display).

In some examples, the method 500 may include an operation 516 to carry out a post-purchase action associated with a selected virtual UI element. The operation 516 may optionally be performed using any one or more of operation 518, operation 520 and/or operation 522, for example.

For example, at the operation 518, a prompt may be provided (e.g., via the image output device 362) to perform a physical manipulation of the detected real-world object. The prompt may itself be the selected virtual UI element, or may be provided as another virtual element following selection of the selected virtual UI element. The prompt may, for example, prompt the user to manipulate the object in order to show a particular view of the object (e.g., if the post-purchase action is to create a review video), in order to show a product identifier (e.g., if the post-purchase action is to initiate a refund or exchange, or the post-purchase action is to purchase or claim a warranty), in order to show an alleged defect (e.g., if the post-purchase action is to report a defect), in order to change the configuration or shape of the object (e.g., if the post-purchase action is to view an interactive user manual), etc. The post-purchase action may be completed after the prompted physical manipulation has been performed. Thus, the AR interface may result in the physical manipulation of the real-world physical object.

In some examples, after prompting the user to physically manipulate the real-world object, subsequent input frame(s) from the image capture device may be processed by the AR interface generator 300 to confirm that the physical manipulation has been performed. For example, the AR interface generator 300 may use the pose detector 304 to detect whether the pose of the real-world object has changed (e.g., using a trained pose detection neural network and/or by detecting reference markers on the object). The post-purchase action may be completed only after the physical manipulation has been confirmed. This may be useful, for example, to ensure that the user actually has the physical object and not a paper image of the object.

In another example, at the operation 520, image data may be obtained and stored. For example, the image capture device may capture one or more subsequent input frames (e.g., as a video) that includes the detected object. The captured image data may also include one or more virtual objects such as the virtual UI element(s), in which case the captured image data may be AR image data. The captured frame(s) may be communicated to the AR interface generator 300. The AR interface generator 300 may cause the captured frames to be stored as image data in the data facility 325, for example as an AR video or as an AR photograph (or non-AR video or photograph).

In some examples, operations 518 and 520 may both be performed. For example, the physical manipulation of the real-world object may be captured by the image capture device in subsequent input frame(s) (e.g., as a video) and communicated to the AR interface generator 300. In some examples, there may be multiple prompts to perform different physical manipulations of the object (e.g., first and second prompts to show first and second views of the object). The captured subsequent input frames may be tagged with timestamps corresponding to the different prompts. This may enable the stored video to be tagged with timestamps corresponding to different views of the object, for example. In this way, the AR interface may enable a more efficient and seamless way to create a video (which may be an AR video) having different views of an object. This avoids the need for computationally expensive video editing and reduces the amount of user interaction steps, which may enable more efficient use of computing resources.

In another example, at the operation 522, the detected real-world object in the input frame may be compared with reference image data (e.g., the reference image data 332 stored in the data facility 325). The reference image data may represent the ideal or brand new appearance of the identified purchased product. A comparison of the real-world object that is the purchased product to the reference image data may be performed in order to detect a difference, which may reflect a defect, damage, or wear and tear of the purchased product, for example. Completing the post-purchase action may be in response to the detected difference. For example, if the detected difference is a defect or damage, an action to initiate a refund or exchange or to report a defect may be done. In another example, if the detected difference is the wear and tear of the purchased product, an action to initiate a purchase of a newer product may be done.

In some examples, carrying out the post-purchase action associated with the selected virtual UI element may require detecting a product identifier (e.g., a barcode, a QR code, a lot number, etc.) on the real-world object. For example, the product identifier may be required if the post-purchase action is an action to report a defect. If the product identifier is not detectable in the initial input frame processed at the operation 502, the virtual UI element may include a prompt to physically manipulate the real-world object to cause the identifier to be brought into view. Then the post-purchase action may be completed after the product identifier is detected. For example, the object identifier 306 may perform operations to detect the product identifier and to find a match with a stored identifier.

Some example AR interactions are now described, which may be carried out using examples of the present disclosure. It should be understood that these examples are not intended to be limiting. As previously mentioned, post-purchase actions that may be enabled via the AR interface include an action to view an interactive user manual, an action to purchase a warranty, an action to initiate a return or exchange, an action to report a defect, an action to create or view a virtual note, or an action to post a review, among other possibilities. Notably, some post-purchase actions may be valid only within a defined post-purchase temporal range. Further, some post-purchase actions may require the user to physically manipulate the purchased product.

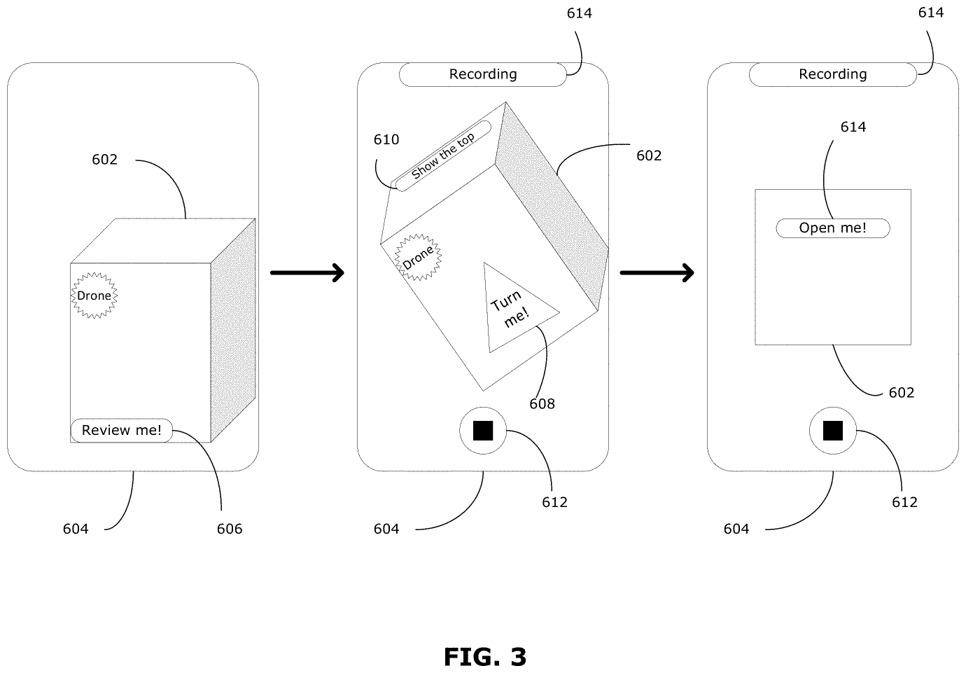

In an example, FIG. 3 illustrates an example sequence of AR displays that may be provided as part of an AR interface, using examples of the present disclosure. In particular, FIG. 3 illustrates an example AR interface that includes a virtual UI element associated with a post-purchase action to create a review for the purchased product.

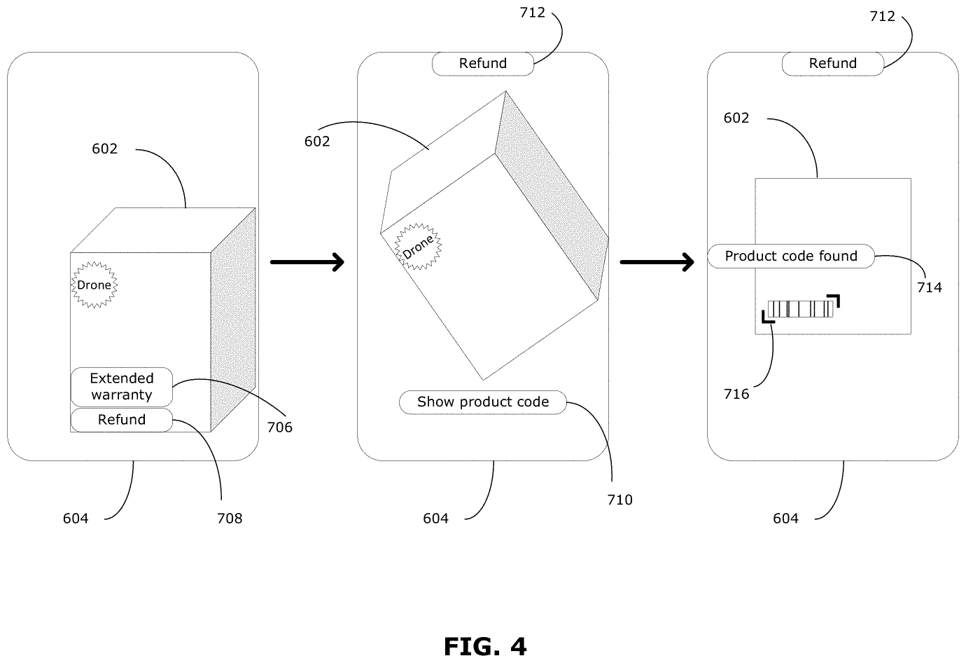

In this example, a real-world object, namely a box 602, is captured by a camera of the user device 350 and a view of the box 602 is displayed on a display screen 604 of the user device 350. For simplicity, background and other objects (e.g., the user's hand) that may also be captured by the camera have been omitted from FIG. 3 (and also from FIG. 4 discussed further below). The captured frame, including the box 602, is communicated to and processed by the AR interface engine 300. Using the object detector 302 and object identifier 306, as described above, the AR interface engine 300 identifies the box 602 as an identified purchased product in the purchase history 322 of an identified user account of the user using the user device 350. For example, the object detector 302 may detect the box 602 as a real-world object in the captured frame, and the object identifier 306 may use computer vision algorithms to match the label and general appearance of the box 602 with reference image data of a particular product in order to identify the box 602 as the particular product (e.g., a Brand C drone). The identified product may then be identified as a purchased product in the purchase history 322 of the user's personal user account.

A virtual UI element 606 is provided, in this example a virtual selection button associated with an action to create a review for the identified purchased product. The virtual UI element 606 in this example is superimposed on the box 602. The action to create a review may be identified from available post-purchase actions based on, for example, a set of predefined post-purchase action(s) for the identified product and/or the purchase date of the identified product being within a predefined temporal range that is valid for creating a review. For example, the action to create a review may only be valid for purchases within the past 10 days (e.g., to avoid stale reviews and/or to encourage customers to post reviews as soon as possible). The user may interact with the display 604 to select the virtual UI element 606.

Selection of the virtual UI element 606 causes the AR interface to change to virtual prompts 608, 610 to physically manipulate the box 602 so as to show a particular view of the box 602, in this example to show the top (e.g., in order to show a particular feature of the product, in order to begin opening the box 602 for an unboxing video, etc.). The AR interface may include additional virtual elements relevant to the action to create a review, such as a stop button 612 to end the recording of the video review and a virtual notification 614 indicating that the review is being recorded. The user may provide voice input (e.g., a spoken review) as the box 602 is being manipulated, for example, which may be recorded as part of the video review. In other examples, the ability to record the video review may be paused or prohibited until the prompted physical manipulation of the box 602 has been performed.

In another subsequent frame, the box 602 has been manipulated as prompted. The AR interface engine 300 may, for example, process the subsequent frame using the pose detector 304 to confirm that the box 602 has been physically manipulated. The video review may now be permitted to be recorded in the case where the video review was paused or prohibited until the physical manipulation was performed. In the case where the video review could be recorded during physical manipulation of the box 602, the video review may continue to be recorded. After the box 602 has been physically manipulated according to the prompt, the AR interface may be updated to include another virtual prompt 614 to perform a second physical manipulation, in this example to open the box 602 (e.g., to guide the user to create an unboxing video, to guide the user to review the product in the box 602 in a brand-new condition, etc.).

The AR interface may continue over a number of further interactions, with possible additional virtual prompts and physical manipulations, until the video review is complete (e.g., all virtual prompts have been performed and the user has selected the stop button 612). The sequence of frames may be stored in the local memory of the user device 350 and/or communicated to the AR interface generator 300 to be stored in the data facility 325 as a video review. If the user also provided a numerical rating for the reviewed product, the numerical rating may be stored in association with the video review. In some examples, the video review may include timestamps that indicate the frames within the video review corresponding to each physical manipulation (e.g., by correlating the time when the virtual prompt for a given physical manipulation was rendered with the time when the frame was captured). For example, the video review may include a first timestamp indicating the frame when the physical manipulation to show the top of the box 602 starts, and a second timestamp indicating the frame when the physical manipulation to open the box 602 starts.

As illustrated in this example, the present disclosure provides an AR interface that enables a seamless and intuitive way for a user to carry out a post-purchase review. Conventionally, reviews are solicited for a recently purchased product through the use of emails sent a fixed number of days (e.g., three days) after a purchase. However, the user might not have received the product at the time the email is received. By the time the user has received the product, the email might be deleted or forgotten. Even if the email arrives after the user has received the product, the user might receive the email at a time or place where the product is not accessible. In this example, the disclosed AR interface generator 300 enables a better user experience that makes the post-purchase action available to the user after detecting the product and after ensuring that the purchase was made within a valid temporal range for creating a post-purchase review. Further, the AR interface generator 300 provides virtual UI elements, including prompts, that guide the user to physically manipulate the product in order to create the review and automatically timestamps those physical manipulations within the video review. Thus, a very efficient and computationally inexpensive way to create a high quality video review is enabled.

In another example, FIG. 4 illustrates an example sequence of AR displays, which may be provided using examples of the present disclosure, in which the AR interface includes a virtual UI element associated with a post-purchase action to initiate a refund for the purchased product.

Similar to the example of FIG. 3, a real-world object, namely a box 602, is captured by a camera of the user device 350 and a view of the box 602 is displayed on the display screen 604 of the user device 350. The captured frame, including the box 602, is communicated to the e-commerce platform 100 and processed by the AR interface engine 300. Using the object detector 302 and object identifier 306, as described above, the AR interface engine 300 identifies the box 602 as an identified purchased product in the purchase history 322 of an identified user account of the user using the user device 350.

In this example two virtual UI elements 706, 708 are provided, namely a first virtual selection button associated with an action to purchase an extended warranty and a second virtual selection button associated with an action to initiate a refund. Each post-purchase action that is associated with a displayed virtual UI element 706, 708 may be identified from available post-purchase actions based on, for example, a set of predefined post-purchase action(s) for the identified product and/or the purchase date of the identified product being within a predefined temporal range that is valid for each post-purchase action. Notably, each post-purchase action may be associated with a respective predefined temporal range. For example, the action to purchase an extended warranty may be valid for one year from the purchase date, however the action to initiate a refund may only be valid for 30 days from the purchase date. In this example, the user interacts with the display 604 to select the virtual UI element 708 associated with the action to initiate a refund.

Selection of the virtual UI element 708 causes the AR interface to change to a virtual prompt 710, as shown in a subsequent captured frame, to physically manipulate the box 602 so as to show a product code (e.g., in order to collect information required for initiating the refund request to the merchant). The virtual prompt 710 in this example is not superimposed on the box 602. The AR interface may include additional virtual elements relevant to the action to initiate the refund, such as a virtual notification 712 indicating that the refund is requested.

In another subsequent frame, the box 602 has been manipulated as prompted and the product code is captured in the frame. The AR interface generator 300 may, for example, process the subsequent frame to detect and recognize the product code. The AR interface in this example has been updated with another virtual notification 714 indicating that the product code was detected, and virtual brackets 716 bordering the detected product code. After the box 602 has been physically manipulated so that the product code is detected, the interaction manager 310 may extract the product code from the captured image (e.g., by converting the product code from alphanumeric, barcode or QR code into digital data). The interaction manager 310 may communicate with the commerce management engine of the e-commerce platform 100 to initiate a refund transaction associated with the product code. In some examples, the interaction manager 310 may also cause one or more of the captured frames to be saved and associated with the refund request.

The AR interface may continue over a number of further interactions to prompt the user to perform additional physical manipulations to show that the product has not been opened and/or is undamaged, and additional frames may be captured to show the condition of the product. Using the pose detector 304, for example, to confirm the prompted physical manipulations, the AR interface engine 300 may ensure that appropriate views of the product are captured as a merchant may need to verify the condition of the product before approving a refund. The captured frames may be communicated to the e-commerce platform 100 and saved as 2D images associated with the refund request. The refund request may be provided together with the saved images for a merchant's approval.

As illustrated in this example, the present disclosure enables an AR interface that may guide a user through the process for initiating a refund. For example, the disclosed AR interface generator 300 may ensure that the refund request is made within a valid temporal range and that the merchant is provided with sufficient information to approve and process the refund request. In particular, the AR interface prompts the user to physically manipulate the product in a way that enables information to be collected, which would otherwise not be available to the merchant until much later (e.g., when the physical product has been shipped back to the merchant). This helps to reduce wasting shipping resources and computer resources that would otherwise be consumed in sending back and processing a product that would not be refundable (e.g., has already been opened or has been damaged).

The AR interface generator 300 may generate an AR interface that includes other virtual objects (not necessarily limited to virtual UI elements). For example, after identifying the real-world object, the AR interface generator 300 may identify one or more products (which may be available for purchase at an online store) that are relevant to the identified object (e.g., relevant products may be defined by a list of accessories and/or related products, stored at the online store, associated with the identified object). The AR interface generated by the AR interface generator 300 may include a virtual UI element that can be selected to display a virtual model of a relevant product superimposed on the real-world object. For example, if the real-world object is identified as a stroller, a virtual UI element may be provided that, when selected, results in a virtual model of a cup holder to be displayed in the AR interface superimposed on the handlebar of the stroller (where the actual cup holder would be installed in real life). In other examples, the virtual UI element may be elected to display a virtual color, virtual pattern or virtual texture superimposed on the real-world object, which may enable the user to visualize, via the AR interface, purchasable options to update an already purchased product (e.g., to purchase new upholstery for a sofa). Other such scenarios for visualizing add-ons to a purchased product may be enabled by the AR interface generated by the AR interface generator 300.

Although FIGS. 3 and 4 illustrate examples in which the AR interface generator 300 is used to generate an AR interface provided via a display screen, it should be understood that the disclosed AR interface generator 300 may be used to generate AR interfaces for other output devices. For example, the AR interface may be provided via a viewport of a HMD device, a windshield projection, a holographic projection, etc.

In some examples, the AR interface generator 300 may be implemented in the context of the e-commerce platform 100. However, it should be understood that the e-commerce platform 100 described herein is only one possible example and is not intended to be limiting. It should be understood that the present disclosure may be implemented in other contexts, and is not necessarily limited to implementation in an e-commerce platform.

### An Example E-Commerce Platform

Although integration with a commerce platform is not required, in some embodiments, the methods disclosed herein may be performed on or in association with a commerce platform such as an e-commerce platform. Therefore, an example of a commerce platform will be described.

FIG. 5 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 5, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data facility 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

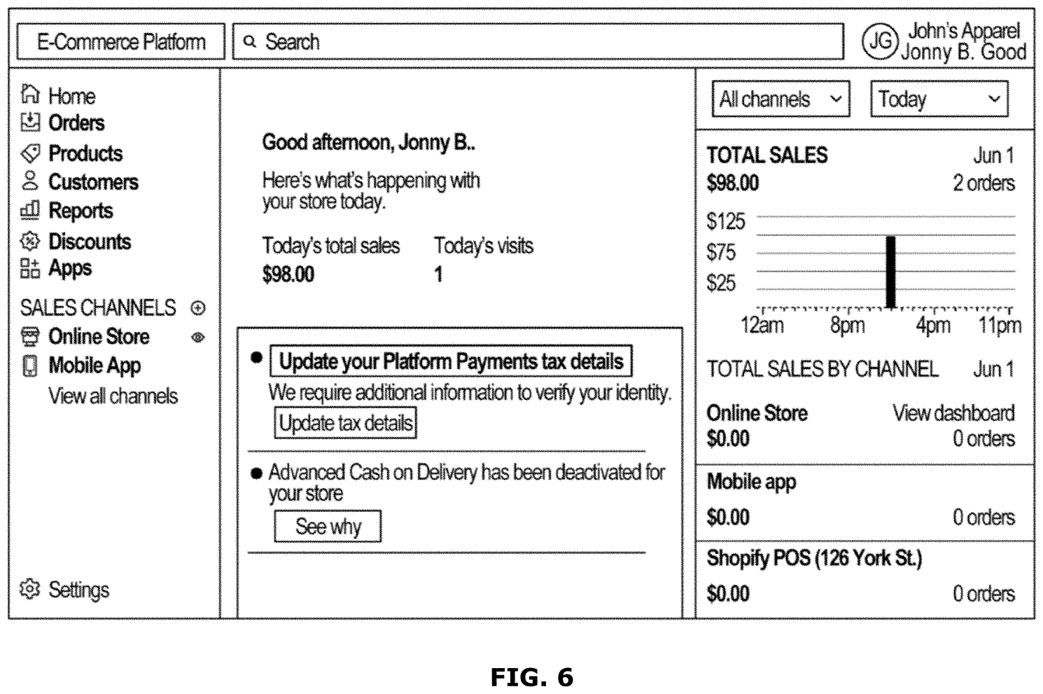

FIG. 6 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 6. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 5, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

In some examples, the applications 142A-B may include an application that enables a user interface (UI) to be displayed on the customer device 150. In particular, the e-commerce platform 100 may provide functionality to enable content associated with an online store 138 to be displayed on the customer device 150 via a UI.

Implementation in an E-Commerce Platform

The functionality described herein may be used in commerce to provide improved customer or buyer experiences. The e-commerce platform 100 could implement the functionality for any of a variety of different applications, examples of which are described elsewhere herein. In particular, in some examples the AR interface generator 300 may be implemented as part of the e-commerce platform 100 to enable functionality related to generation and/or viewing of an AR interface.

FIG. 7 illustrates the e-commerce platform 100 of FIG. 5 but including the AR interface generator 300. In examples where the AR interface generator 300 is included in the e-commerce platform 100, the data facility 325 shown in FIG. 1 may be an instance of the data facility 134 of the e-commerce platform 100. Although the AR interface generator 300 is illustrated as a distinct component of the e-commerce platform 100 in FIG. 7, this is only an example. The AR interface generator 300 could also or instead be provided by another component residing within or external to the e-commerce platform 100. In some embodiments, either or both of the applications 142A-B may provide an embodiment of the AR interface generator 300 that implements the functionality described herein. In other examples, the AR interface generator 300 may be provided by a separate AR platform or system that cooperates with the e-commerce platform 100. It should also be understood that the AR interface generator 300 may be implemented independently of any e-commerce platform 100. In general, the location of the AR interface generator 300 may be implementation specific and the AR interface generator 300 is not necessarily part of or dependent on the e-commerce platform 100.

In some implementations, the AR interface generator 300 may be provided at least in part by the e-commerce platform 100, either as a core function of the e-commerce platform 100 or as an application or service supported by or communicating with the e-commerce platform 100. For simplicity, the present disclosure describes the operation of the AR interface generator 300 when the AR interface generator 300 is implemented in the e-commerce platform 100, however this is not intended to be limiting. For example, at least some functions of the AR interface generator 300 may by additionally or alternatively be implemented on the customer device 150 (e.g., an instance of the AR interface generator 300 or certain functions of the AR interface generator 300 may be implemented as an application executed by the customer device 150).

In some implementations, the examples disclosed herein may be implemented using a different platform that is not necessarily (or is not limited to) the e-commerce platform 100. In general, examples of the present disclosure are not intended to be limited to implementation on the e-commerce platform 100.

In the examples of FIGS. 5 and 7, a merchant device 102 associated with a merchant is shown. Additionally, a product provider or manufacturer may communicate with the e-commerce platform 100 via respective electronic devices (e.g., a product provider device or a manufacturer device). The product provider or manufacturer may be a distinct party from the merchant (i.e., the merchant is not necessarily also the provider or manufacturer of the product). In some examples, the e-commerce platform 100 may facilitate customer interactions with the manufacturer (rather than with the merchant). For example, interactions such as requesting technical support, purchasing a spare part or purchasing a warranty may be between the customer and the manufacturer directly (rather than via the merchant). The e-commerce platform 100 may also allow a manufacturer to access collected data (e.g., data about frequency of product returns or warranty claims) that may be useful to the manufacturer.

The disclosed AR interface generator 300 may enable various post-purchase actions to be completed via an AR interface. Some possible post-purchase actions include, for example, viewing an interactive user manual, reporting a defective or damaged product, creating a review, creating an unboxing video, purchasing a warranty or extended warranty, restocking a consumable product, purchasing a replacement for a worn-out product, creating or viewing a virtual note, etc.

In some examples, the present disclosure may enable generation of an AR interface that enables pre-purchase actions instead of or in addition to post-purchase actions. For example, after a real-world object has been detected, it may be determined that the object is available for purchase from an online store. In such a scenario, it may not be necessary to identify that the detected object is a purchased product. The virtual UI element(s) provided in the AR interface may, instead of or in addition to being associated with post-purchase action(s), be associated with pre-purchase action(s). For example, a pre-purchase action that may be associated with a virtual UI element provided via the AR interface may be an action to view a review, an action to initiate a purchase transaction, an action to navigate to an online product page, an action to view a video demonstration of the product, an action to add the product to a wish-list, an action to activate a discount (which may be time-limited), etc.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method comprising:
processing an input frame captured by an image capture device to detect and track an object in the input frame;
identifying the detected object as an identified purchased product based on a query of a purchase history associated with an identified user account; and
in response to identifying the detected object as the identified purchased product, providing, via an image output device, one or more virtual user interface elements associated with respective one or more post-purchase actions.

2. The method of claim 1, further comprising:
determining a temporal difference between a purchase time of the identified purchased product in the purchase history and a current time; and
identifying the one or more post-purchase actions for which the associated one or more virtual user interface elements is to be provided, based on the temporal difference.

3. The method of claim 2, the one or more post-purchase actions are identified from a set of available post-purchase actions, wherein each available post-purchase action is associated with a respective post-purchase temporal range, and wherein the one or more post-purchase actions are identified based on a match between the determined temporal difference and the respective post-purchase temporal range associated with each respective one or more post-purchase actions.

4. The method of claim 1, wherein one of the one or more virtual user interface elements is a prompt to perform a physical manipulation of the detected object, and wherein the post-purchase action associated with the one virtual user interface element is completed after performance of the physical manipulation.

5. The method of claim 4, wherein completion of the post-purchase action comprises:
storing one or more subsequent input frames, captured by the image capture device, including the detected object during or after performance of the physical manipulation.

6. The method of claim 5, wherein the one virtual user interface element is a first prompt to perform a first physical manipulation of the detected object, wherein subsequent to the first prompt a second virtual user interface element is provided that is a second prompt to perform a second physical manipulation of the detected object, and wherein the stored one or more subsequent input frames are tagged with timestamps corresponding to the first prompt and the second prompt.

7. The method of claim 4, further comprising:
processing one or more subsequent input frames, captured by the image capture device, to confirm performance of the physical manipulation of the detected object; and
completing the post-purchase action associated with the one virtual user interface element in response to confirming the performance of the physical manipulation.

8. The method of claim 7, wherein confirming the performance of the physical manipulation comprises:
processing the one or more subsequent input frames to detect a change in pose of the detected object or to detect a changed reference marker on the detected object.

9. The method of claim 4, wherein completion of the post-purchase action comprises:
detecting a difference in the detected object based on a comparison between a captured image of the detected object after performance of the physical manipulation and a stored previous image of the detected object or a reference object associated with the identified purchased product; and
completing the post-purchase action associated with the one virtual user interface element in response to the detected difference.

10. The method of claim 4, wherein completion of the post-purchase action comprises:
detecting, in a captured image of the detected object after performance of the physical manipulation, an identifier; and
completing the post-purchase action associated with the one virtual user interface element in response to the detected identifier matching a stored identifier of the identified purchased product.

11. The method of claim 1, further comprising:
identifying the one or more post-purchase actions for which the associated one or more virtual user interface elements is to be provided, based on a predefined set of one or more post-purchase actions associated with the identified purchased product.

12. The method of claim 1, wherein at least one of the one or more virtual user interface elements is provided as a virtual overlay superimposed on the detected object.

13. The method of claim 1, wherein the one or more post-purchase actions include at least one of:
an action to view an interactive user manual;
an action to purchase a warranty;
an action to initiate a return or exchange;
an action to report a defect;
an action to create or view a virtual note; or
an action to post a review.

14. An apparatus comprising:
a processing unit coupled to communicate with an image capture device and an image output device, wherein the processing unit is configured to:
process an input frame captured by the image capture device to detect and track an object in the input frame;
identify the detected object as an identified purchased product based on a query of a purchase history associated with an identified user account; and
in response to identifying the detected object as the identified purchased product, provide, via the image output device, one or more virtual user interface elements associated with respective one or more post-purchase actions.

15. The apparatus of claim 14, wherein one of the one or more virtual user interface elements is a prompt to perform a physical manipulation of the detected object, and wherein the post-purchase action associated with the one virtual user interface element is completed after performance of the physical manipulation.

16. The apparatus of claim 15, wherein the processing unit is further configured to:
process one or more subsequent input frames, captured by the image capture device, to confirm performance of the physical manipulation of the detected object; and
cause completion of the post-purchase action associated with the one virtual user interface element in response to confirming the performance of the physical manipulation.

17. The apparatus of claim 15, wherein completion of the post-purchase action comprises:
detecting a difference in the detected object based on a comparison between a captured image of the detected object after performance of the physical manipulation and a stored previous image of the detected object or a reference object associated with the identified purchased product; and
completing the post-purchase action associated with the one virtual user interface element in response to the detected difference.

18. The apparatus of claim 14, wherein the processing unit is further configured to:
determine a temporal difference between a purchase time of the identified purchased product in the purchase history and a current time; and
identify the one or more post-purchase actions for which the associated one or more virtual user interface elements is to be provided, based on the temporal difference.

19. The apparatus of claim 14, wherein the apparatus is one of:
a smartphone;
a tablet;
a wearable device; or
a projection device.

20. A non-transitory computer readable medium having instructions stored thereon, wherein the instructions, when executed by a processing unit of an apparatus, cause the apparatus to:
process an input frame captured by an image capture device to detect and track an object in the input frame;
identify the detected object as an identified purchased product based on a query of a purchase history associated with an identified user account; and
in response to identifying the detected object as the identified purchased product, provide, via an image output device, one or more virtual user interface elements associated with respective one or more post-purchase actions.
